(19) United States
(12) Patent Application Publication
(10) Pub. No.: US 2006/0173103 A1
(43) Pub. Date: Aug. 3, 2006

(54) Damping material and method for the production thereof

(76) Inventor: Axel H. Schmidt, Trebur (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/540,192

(22) PCT Filed: Dec. 19, 2003
(86) PCT No.: PCT/EP03/14668

§ 371 Date: Mar. 9, 2006

(30) Foreign Application Priority Data
Dec. 20, 2002 (DE) 102 60 922.5

(51) Int. Cl. C08L 97/02; C08K 9/04

(52) U.S. Cl. 524/9; 524/445

(57) ABSTRACT

A deadening material especially for automobiles having a binding agent and a filler material based on straw. The straw is chaffed, shredded and/or disintegrated.

This invention covers a deadening material in general and a deadening material composed for application in vehicles in particular as well as a process for its production.

Deadening material is especially used manifold in the automobile production in form of deadener pads. For example a number of sheet metal parts of the vehicle body are combined with deadening pads.

The material components of the basic compound of the said group of deadening materials consists usually of
a binding agent or a binding mixture and
one or more filler substances.

As binding agents a number of materials and material mixtures are known. For example in the patent description DE 692 16 238 T2 a composition of ethyl-vinyl ace tat copolymer and petroleum resin is mentioned.

As filler substances are in use for instance minerals like basalt, mica and so on and substances which increase the scope of usage of the deadening pad for example magnetizable elements.

In addition it is possible that further, depending on the specific usage situation, necessary supplements are added to the filler substance like surface active substances, softeners etc.

These kinds of deadening materials cause problems in the waste treatment and in the receicling process and they are disadvatageously relatively heavy.

The weight of the presently known deadening materials, which are nowadays used in automobile production, sum up for a middle class car typically to about 25 kg plus, which is never the less about 2 percent of the units gross weight.

A negative effect is that because of the weight of the deadening material directly the fuel consumption of the automobile increases.

On the other hand we have in the wake of steadily increasing fuel prices an enormous pressure on the automotive industry to reduce the vehicle weight.

From document DE 38 13 984 A1 a procedure, for manufacturing of form pressed shock absorbing parts, is known, in which the straw by grinding is split and ground down to straw particles, which are mixed with a water based glue. The mixture consisting of straw particles and glue is finally pressed into a form and the shaped part is dried.

During the grinding process, in a negative form, flour dust results which can lead due to electro-static charging to a considerable danger of explosion.

A disadvantage, even more serious, is based on the fact that a very important positive feature of the straw, the fibres, during the grinding process are destroyed.

From document DE 196 41 588 A1 a deadening material is known which contains straw that has been soaked in a soda- or potash lye and as needed added with other ingredients is formed into a specific part.

But this deadening material has the disadvantage that the straw in the soaking process only gets somewhat softer and bendable. This maybe is sufficient for the mentioned application in the construction industry, in the automotive industry this kind of deadening material is however, because of the fundamentally different basic requirements, not usable.

Furthermore, from the document DE 195 43 635 A1 a material based on polyhydroxy fatty acid and fibre materials is known, which is also suggested for the production of form parts for the automotiv industry.

These form parts are suggested to cover steel in the interior, they are assembled to the body therefore they do not have any deadening effect. Sound in this way is not silenced or prevented as it arises, so as a result the sheet metal parts of a car boby vibrate and create sound.

Consequently it is one task of the submitted invention to provide a sound deadening material that is cost effective to produce, compatible with the environment and/or has a has a reduced weight.

Another task of the invention is to provide a deadening material which has good sound- and/or heat isolation characteristics and especially a sound neutralizing characteristic that minimizes and softens vibration leading to a lower booming level.

An additional task of the invention is to provide a deadening material which is simple and safe to process.

Still another task of the invention is to provide a deadening material which is flexible and has a good forming ability.

It is also a task of the invention to provide a deadening material which eliminates or at least reduces the disadvantages of the traditional material.

The tasks of the invention is already solved in a surprisingly simple way by the subject of the independent claims. Advantageous further improvements of the invention are subject of the dependent claims.

Based on the invention a basic material for producing a deadening material for automobiles respectively the deadening material itself is provided, which contains at least one binding agent, whereby binding agent also includes a binding compound and at least one or more filler substances/materials.

The filler material contains straw or is made of straw. Preferably straw of one kind or sort alone or a mixture of them is used.

Especially efficient and effective wheat- and rye straw has proven.

A special preference of the invention lies in the usage of decomposed/disintegrated straw, whereby under disintegration of the straw it is understood that the natural solid fibre structure of the straw is at least partly annulled.

By the disintegration in a favourable way the natural structur of the straw in the form of fibres bound to stalks, thus its stalky and stiffend structure, is at least partly lost.

By the disintegration of the straw it happens that, in other words, the straw fibres which make up the stalks together with natural binding substances are extracted from this natural structure of the straw stalks.

The stalk structure, which is created by a natural pentosan-, lignin- and/or cellulose binding of the straw fibres to straw stalks, is in the process of disintegration unfastened in a way that the natural structur of the straw in its original form of straw stalks, build of fibres, is at least partly broken up.

To disintegrate the straw it is especially cooked in a solution under steam pressure at a temperature of 80° C. up to 150° C. or higher for instance in a steam pressure boiler.

To unbind the stalk ingredients has in the deadening material the advantage that the binding material mixed with the fibres reduces the dropping of material in an overhead position and increases the deadening ability.

The disintegrated straw has the advantage that on one hand the originally or naturally existing stiffness of the straw is eliminated or at least reduced and on the other hand the fibers are preserved by which an excellent processable, formable and still endurable deadening material is created.

In addition the deadening material according to the invention distinguishes itself by a cost effective manufacturability as well as very good acoustic deadening, especially body-sound deadening and the oscillation-/vibration deadening at the lowest achievable weight.

The said deadening material can also be used in any kind of rail carriage, airplane, any type of vessel, elevators or any other transportation means as well as any utensils of all sort. With the basic material respectively the deadening material it is additionally possible to prepare different locations as e.g. studios, concert halls and/or buildings especially production halls or similar objects for sound deadening.

Also a usage of straw in roofing felts for wall or roof insulation is possible.

Especially, according to the invention, the up to now known and used filler materials are partly or totally replaced or complemented by straw.

Filler agents which give the deadening material particular characteristics, which are needed for the type of application, remain preferably unchanged based on the technical standing.

Especially deadening pads for the automotive industry are produced from the inventional deadening material.

Straw is a material used since prehistoric times of mankind, which has been nearly forgotten in recent times and therefore is hardly used where it is in vast supply. Even worth, outside West Europe it is burned or left to rot, since there is no economical usage. The present invention can help to remedy that.

Of particular advantage is to highlight, that straw is a raw material annually reproduced by nature which guaranties highest environmental standards.

Beyond that is straw and preferably the inventional base material and the deadening material made of it rottable or burnable so that also at the point of disposal the environmental burden can be kept reasonably low. Also an environmentally favorable recycling of the deadening material is possible.

But also the technical advatages of straw as filler material for producing the inventional base material respectively the deadening material are considerable. Straw distinguishes itself by a lesser, especially compared to the known filler materials, specific weight respectively a much reduced density. This weight advantage is also maintained if, as is especially provided for, the straw stalk is disintegrated to improve the features of the deadening material.

Preferably has, as the case may be, pressed straw, before it is mixed with the binding material, a density of less or equal than 2000 kg/cm, preferred less or equal 1000 kg/cm, especially preferred less or equal 500 kg/m and most preferred in the area of 280 kg/cm +/−50% or +/−25%. In comparison basalt (2600 to 2800 kg/cm) or schist (2600 to 2700 kg/cm) have a much higher density. (cm=cubic meter)

The reduced weight in comparison leads to a direct and environmentally favourable reduction of the fuel consumption of the vehicle in which the new material is used.

Therefore preferably in relation to the total volume a maximized straw filler material portion depending on the task on hand is aimed for.

Additionally the inventional deadening material distinguishs itself by a high sound insulation respectively sound absorbtion over a wide frequency range.

Preferably the filler material, precisely the straw, is, before it is mixed with the binding material, undergoing a pretreatment. This pretreatment can consists to begin with cleaning the straw if necessary. After that, especially before the disintegration process, the straw can additionally be reduced into particles for instance by cutting, chaffing respectively shredding and that in a way that the straw fibres compared to their natural length have a reduced length. Alternatively to the disintegration process it can be sufficient for some applications to just chaff or shred the straw.

Chaffing respectively shredding has, compared to grinding, fundamentally the great advantage that few or hardly any flour is encountered which means the electrostatic charging of the filler material is extremely low.

Following, the straw is preferably imprenated against rottenness and/or inflammability and maybe subsequently dried.

According to a benefitial progress of the invention the deadening material is thermical or heat fusible.

For this purpose a thermically fusible binding agent, especially based on bitumen in construction or road building quality, ethylene-vinylacetate-copolymers and/or fossil resins are used and/or other basically known at high temperatures fusing ingredients are added.

Preferred fusing temperatures or softening marks are situated in the area of 70° to 130° celsius. Preferably the deadening material is transformed into a defined deadening pad which is in a further process step united with a carrier part, that has to be deadened, by fusing.

In a beneficial manner the deadening material because of the combination of straw and its particles and the bitumen has particularly favourable fusing characteristics.

As especially beneficial a binding material, has proofen which is of construction quality, used for first class roofing felts. It has the advantage that it contains sythetic coutshouk. In this regard it has shown that a binding material that contains in particular synthetic rubber is improving the invention related characteristics.

The deadening material according to the invention has besides an excellent sound absorption another positive feature so that because of the invention a double benefit results. Advantageously the deadening material according to the invention has in comparison to the traditional deadening materials a reduced heat conduction, it has a high heat insulation.

The considerable weight reduction in line with an improvement of the sound absorbtion coefficient is for nearly all applications in car production possible e.g. for the roof, that is hanging in an overhead position in the side panel area, that is in a vertical position and for a floor panel application which means a lying position.

For deadening of the floor pan and the bottom of a trunk particle sizes after chaffing respectively shredding of up to 6 mm in length and 4 mm in diameter and up to 4 mm in width have proven best. At this length of the fibres the deadening pad can optimal adjust to the contour of the floor during the fusing process.

For deadening pads for the roof the fibre length can be longer since radii on roofs are not as small.

In particular the fibre length used is adjusted to the smallest radius on the part to be deadened by a deadening pad.

Therefore the straw fibres have preferably a length of less or equal 100 mm, 50 mm, 25 mm, 10 mm or 6 mm.

Hereby the inventor found that the stalks respectively the tube/pipe particles during the mechanical cutting process, if less than 30 mm in length, possibly part.

The tube- or filler particles crack, especially along their longitudinal axis, into two or more tubular formed segments or hollow cylinder formed segments.
Preferably straw comes to use which has a raw fibre weigth portion of 15% to 75%, preferably in the area of 45%+/−15 percentage points, a lignin weigth portion of 10% to 40%, preferably in the area of 25%+/−10 percentage points, a pentosan weigth portion of 0% to 40%, preferably in the area of 20%+/−10 percentage points and/or a cellulose weigth portion of 0% to 60%, preferably in the area of 30%+/−15 percentage points.

Preferably the deadening material includes or consists of the following ingredients (portion of volume): bitumen 20 to 40%, preferably minimal, elastomer/natural rubber 0 to 20%, preferably 10% straw, shredded and/or disintegrated 10 to 80%, preferably maximal, kaolin/clay 0 to 20%, preferably minimal, triethyl phosphate 1 to 10%, preferably about 3% ferrit powder 5 to 20%

Especially for installation in the roof area the deadening material is supplemented with a portion of magnetizable material e.g. ferrit powder, in an amount capable to hold the deadening pad in place till it is fused to the roof in the paint shops drying oven permanently.

Because of the definite lower weight of the inventional material compared to traditional deadening material also the portion of ferrous material to create the magnetic power necessary can be reduced. This effect favourably leads to an involution in the weight reduction of the vehicle. Moreover, it is in the scope of the invention to provide a process for producing a deadening material which includes a binding material and a filler material, straw with its ingredients pentosan, lignin, cellulose and fibres. Depending on the task the deadening material is processed further to match the demands on hand.

Preferred steps in the further treatment of the straw, which can especially be done alone or multiple and/or in combination and/or in the following order are:
to chop the straw or the filler material
to part or cut the straw or the filler material into particles
shredding the straw or filler material into particles
impregnating the straw or filler material
drying the straw or filler material
to blend the cut up straw or filler material with binding material to a basis material
adding of kaolin and/or clay
to press, pour and/or roll the basis material
form the basis material to a deadening element or a deadening pad and
heat fusing of the deadening element with a carrier element of a body panel.

The temperature for blending/mixing is preferably at least 60° C., especially preferred at least 80° C. and/or at the most 250° C., especially preferred a temperature of 140° C.

Following the invention will be explained more closely by the means of execution examples, whereby the characteristics of the different execution examples can be combined with each other.

### DETAILED DESCRIPTION OF EXECUTION EXAMPLES OF THE INVENTION

The inventional deadening material respectively the base material consists of organic and inorganic substances. The single components of the deadening material vary and are dependent on the use and application and the special problem solving task of the deadening material.

Experiments have proven that a careful selection and composition of the basic components will bring the required results.

The following material compositions where found to be advantageous examples, whereby the data is to be understood as volume percentages:

Sample 1

Bitumen, street building quality 55%

Divinylstyrolthermoplastic 10%

Straw 25%

Kaolin 7%

Trietethyl phosphate 3%

Sample 2

Bitumen, street building quality 45%

Chlorine-butadiene caoutchouc 10%

Straw, shredded 35%

Kaolin 10%

Sample 3

Bitumen, costruction quality 40%

Divinylstyrolthermoplastic 15%

Straw 32%

Kaolin 10%

Triethyl phosphate 3%

Sample 4

Bitumen, construction quality 40%

Styrene-butadiene caoutchouc 10%

Straw 30%

Kaolin 10%

Trie 3%

Fer . . . 7%

To produce the samples 1 to 4 the straw has been chaffed, shredded or disintegrated which led as the tests showed to a better stirability/kneadability with the other ingredients.

For chopping the straw or shredding it, the straw is bundled in a compact form, inserted into a cutter consisting of a rotating spiral which has at the end a rotating blade pressed against a perforated disk performing the cutting/chopping process.

The result of the cutting process of the dry straw stalks are particles of 5 micron to 5 mm in length, the width is reduced to max 2 mm. Thus the fibre length has been reduced at least to 10 micron and/or highest to 5 mm.

For mixing the components a stirring-/kneating machine was used. In a first step the bitumen and the caoutchouc ingredients were mixed for 3 to 20 minutes.

After that in a second step the other material components were added and mixed for about 3 to 30 minutes. The selected revolutions for mixing varied between 30 to 90 turns per minute.

The temperature while mixing should be in the first and/or second step between 100° C. and 150° C., especially in the area of 150° C. By this proceeding a very homogeneous material mixing was achieved.

Additionally the time of the true mixing can be reduced if the materials to be mixed with the bitumen when entered into the mixing process have been preheated to at least 60° C., preferably 100° C.

During the mixing process of the straw with the other ingredients, that is during the stirring and kneating process at about 130° C. it is assumed that here already a mini disintegration of the straw particles is taking place. Without the claim of entirety or correctness, it is assumed that about a 20 percent disintegration is achieved which would explain the surprisingly good test results.

The test material produced in this way was rolled out to a thickness of 2 mm.

To produce the samples 5 and 6, in the following described, the material component straw was disintegrated without being shredded before. The disintegration, by the way, can also be done in combination, more precise after, the aforementioned chaffing or shredding.

The samples 5 and 6 consist of:

Sample 5

Bitumen, street building quality 30%

Divinylstyrolthermoplastic 10%

Straw, disintegrated 50%

Kaolin 7%

Triethyl phosphate 3%

Sample 6

Bitumen, construction quality 25%

Chlorine-butadiene caoutchouc 10%

Straw, disintegrated 48%

Kaolin 7%

Triethyl phosphate 3%

Ferrit powder 7%

To produce the material for samples 5 and 6 the natural straw, as delivered from the fields (not shredded), was cooked in a water-calcium oxid (CaO) solution under pressure in a steam pressure boiler and thus totally disintegrated into its chemical and solid substances.

Especially the lignin, pentosan and/or cellulose could be separated from the fibres in the CaO solution.

Therefore, by cooking the straw under pressure in said solution, especially the lignin which binds the straw fibres is set free and as a result the material gets a much better formability.

The cooking operation was, as a first trail, done at 110° C. and a pressure of 10 bar, for a duration of 4 hours. The disintegrated, moistures straw was joined with the bitumen and coutchouk compound at a temperature from 80 to 5 100° C. In other respects proceedings were as with samples 1 to 4.

For the samples 5 and 6, when the moist, dripping wet, disintegrated straw at a temperature of about 100° C. or preheated to it is added and mixed with the bitumen a short steam development is tolerated.

The method and the benefits of disintegration, which is the separation of the straw in its components is in the following described in more detail.

The straw is, as it comes from the field or a storage area, put into a boiling solvent of water in which caustic lime or quicklime is totally dissolved. The lime portion preferably amounts to about one tenth to one half of the full straw weight of the charge to be disintegrated.

When being submerged into the boiling fluid the straw immediately looses it rigidity because the substances of the straw lignin, pentosan and cellulose at once start the disintegration process.

The inventor furthermore found out, that during the cooking process a lime-cilicic acid-compound originates which gives the final deadening material favourably an additional strength.

The mentioned material components, in all samples 1 to 6, lead as an essential part to the following results and advantages.

The bitumen makes it possible to fuse the deadening pad to the panel to be deadened, which means to create a connection between carrier panel and deadening pad which can only be separated by mechanical means.

The elastomer respectively the caoutchouc lead to an improved ability of the deadening material to follow the shape and the radii of the carrier panels during the fusing process. With that an improved adaptability to shape is achieved. The elastomer mentioned in the samples lead additionally to an improvement of the formability of the pads, a reduction in brittleness and to an improved temperature stability against heat and cold.

The straw in chopped, shredded and/or disintegrated form improves the weight of the pads and also improves the deadening characteristics.

By the low density of straw of about 0.28 kg/cdm (cubic dm) compared to bitumen of about 1 kg/cdm there is a considerable weight reduction. In case of a vertical or overhead application this weight reduction is of a significant advantage because the ferrite powder portion can be reduced accordingly.

Adding of kaolin and/or clay deadens especially the sound of higher frequencies and the straw that of lower ones. By that a combined effect is achieved regarding the coverage of a broad frequency range of said deadening material. It is possible at 40° C. to achieve loss factors of mü=0,32 up to 0,44 or even higher.

The limited adding of kaolin and/or clay leads to a further improvement of the thermal stability and the vibration deadening. Since the density of these materials with about 2 kg/cdm is about double to bitumen, the share is preferably minimized.

Triethyl phosphate causes the deadening material to become hardly inflameable. This results in meeting the international automotive standards.

The particle- and fibre share in the sample material leads also to results which exceed the required standards of the automotive industry.

By disintegrating the straw and mixing it with the bitumen in a state of dripping wet, the deadening material is enriched not only with the fibres but also with the lignin, the pentosan, the cellulose and a cilicic acid compound. All these substances apparently enter with the other ingredients of the deadening material into a very advantageous combination, as the test results proofed.

Test Results

The invented deadening material according to samples 1 to 6 was run through tests as required by the potential customers, especially the automotive industry.

Requirements Results

1. Weight

a) unmagnetized<2,5 kg/sqm->lower

b) magnetized<4,5 kg/sqm->lower

2. Thickness 2,0 mm+0,2->met

3. Tensile strength<25 N/sqmm->met

4. Adhesiveness of magnetized sample material

A test pad of the deadening material with the seize of 200 mm×100 mm is lightly pressed to a sheet metal part prepared for painting with the measures 250 mm×100 mm so that 50 mm overlap. The connecting pressure on the overlapping area, 100×50 mm, of the test pad is 5 N. While hung up in a vertical position the test pad is not allowed To shift its position and/or to fall off. ->met

It is recognizable by an expert that the aforementioned and described application samples have to be understood exemplarily and that the invention can be varied in regard to different aspects without deverting from the genius of the invention.

1. A deadening material for production of deadening pads, comprising:
at least one binding material; and
at least one filler material, wherein the at least one filler material comprises natural straw and the natural straw is at least partly disintegrated.

2. The deadening material according to claim 1, wherein said natural straw comprises natural fibre binding that is at least partly neutralized by the disintegration.

3. The deadening material according to claim 1, wherein said natural straw comprises straw stalks bound by straw fibres with the disintegration of the natural straw being at least partly annulled.

4. The deadening material according to claim 1, wherein said at least partly disintegrated natural straw is formed by straw fibres that are dissolved from a natural stalk structure.

5. The deadening material according to claim 4, wherein the natural straw is at least partly neutralized by loosening the natural pentosan-binding, lignin-binding and/or cellulose-binding of the straw fibres.

6. The deadening material according to claim 1, wherein said at least one filler material is boiled.

7. The deadening material according to claim 1, wherein the at least one binding agent comprises bitumen.

8. The deadening material according to claim 1, wherein the natural straws, before disintegration, comprises particles having a shortened length as compared to their natural length.

9. The deadening material according to claim 8, wherein said shortened length comprises shorter than or equal 100 mm.

10. The deadening material according to claim 1, wherein the at least one filler material is impregnated.

11. The deadening according to claim 1, wherein the at least one filler material is treated/impregnated with a substance to make it more combustible resistant.

12. The deadening material according to claim 11, wherein said substance compriese Triethyl phosphate.

13. The deadening material according to claim 1, wherein the at least one filler material is dry and/or pulpy and temperized up to 100° C.

14. The deadening material according to claim 1, wherein the at least one filler material is compressible.

15. The deadening material according to claim 1, wherein the natural straw comprises a density of less or equal to 2000 kg/cbm.

16. The deadening material according to claim 1, wherein the natural straw has a raw fibre share of 15 to 75%, a lignin share of 10 to 40%, a pentosan share of 0 to 40%, and a cellulose share of 0 to 60%.

17. The deadening material according to claim 1, wherein the at least one binding material is heat fusibile.

18. The deadening material according to claim 1, further comprising a portion of magnetizable material.

19. The deadening material according to claim 1, wherein the natural straw is partly chaffed or shredded.

20. A vehicle deadening pad, comprising:
at least one binding material; and
at least one filler material, wherein the at least one filler material comprises natural straw and the natural straw is at least partly disintegrated.

21. A process for producing a deadening material for vehicles, comprising:
providing a filler material which includes straw and a binding agent;
neutralizing the structure of the straw, by disintegration, so that a fibre structure of the straw is freed, as are the lignin, pentosan and cellulose to form a straw pulp; and
mixing the straw pulp with the binding agent.

22. The process according to claim 21, further comprising cooking the straw at least till the fibre structure of the straw is at least partly neutralized.

23. The process according to the claim 21, further comprising cooking the straw and mixing the resulting disintegration while dropping wet with a hot bitumen/caoutchouc compound.

24. The process according to claim 21, further comprising shredding the straw before disintegration.

25. The process according to claim 21, further comprising cooking the straw under pressure at least until the natural pentosan-binding, lignin-binding, and/or cellulose binding of the straw fibres is at least partly disintegrated.

26. The process according to claim 21, further comprising maintaining the temperature during the mixing of the binding agent and the filler material is to between 80° C. and 150° C.

27. The process according to claim 21, further comprising at least one or more of the following process steps:
cutting the filler material,
impregnating the filler material,
drying the filler material,
blending the filler material with other ingredients,
adding of kaolin,
adding of clay,
pressing, casting or rolling the deadening material,
forming the deadening material into a deadening element or a deadening pad, and
fusing the deadening material with a carrier element.

28. The deadening material according to claim 1, wherein the deadening pad is useable for vehicles selected from the group consisting of automobiles, rail cars, air planes and ships.
